(19) United States
(12) Patent Application Publication
(10) Pub. No.: US 2016/0194824 A1
(43) Pub. Date: Jul. 7, 2016

(54) RECORDING METHOD AND INK SET

(71) Applicant: Seiko Epson Corporation, Tokyo (JP)

(72) Inventors: Masakazu OHASHI, Shiojiri (JP); Toru SAITO, Yamagata (JP); Takako SUGIYAMA, Azumino (JP)

(21) Appl. No.: 14/987,001

(22) Filed: Jan. 4, 2016

(30) Foreign Application Priority Data
Jan. 5, 2015 (JP) 2015-000161

(51) Int. Cl. D06P 5/00; C09D 11/107; D06P 1/44; C09D 11/30; D06P 5/22; D06P 5/30; C09D 11/54; C09D 11/102

(52) U.S. Cl. CPC D06P 5/002; C09D 11/54; C09D 11/107; C09D 11/102; C09D 11/30; D06P 5/22; D06P 5/30; D06P 1/44

(57) ABSTRACT

A recording method including depositing onto a recording region of a recording medium a reaction liquid containing a flocculant capable of aggregating constituents in an ink composition or increasing the viscosity of the ink composition, depositing a first ink composition containing a coloring material, polymer fine particles made of a resin being an acrylic resin, and water on the recording region on which the reaction liquid has been deposited, and depositing a second ink composition containing a coloring material, polymer fine particles made of a resin being a urethane resin, and water on the recording region on which the first ink composition has been deposited.

### BACKGROUND

1. Technical Field

The present invention relates to a recording method and an ink set.

2. Related Art

What is called an ink jet recording method has been known, which records information in the form of images and characters with very small ink droplets ejected from an ink jet recording head. In some known methods (for example, Japanese Patent No. 4969578), a white ink as a first ink is applied to a cloth to which a reaction liquid has been applied by ink jet recording for pretreatment, and then a color ink as a second ink is applied onto the white ink by ink jet recording.

From the viewpoint of improving image quality by rapid reaction for forming an aggregate of one or more of the constituents in an ink or increasing the viscosity of the ink, and thus suppressing ink bleeding, and from the viewpoint of improving color developability by preventing the ink from penetrating the cloth, a reaction liquid is used. Unfortunately, the color fastness to washing of the resulting image is reduced in some cases probably because the reaction liquid causes the polymer fine particles in an ink to separate from the liquid component of the ink in an early stage, thereby reducing the adhesion to the cloth. The color fastness to rubbing and the resistance to cracking also tend to be degraded.

This tendency resulting from reducing adhesion to cloth is more marked in the coating of the first ink, which comes directly into contact with the reaction liquid. Furthermore, this tendency is particularly marked when the first ink is deposited onto the reaction liquid not sufficiently dried (in a state where a higher percentage of the volatile component of the reaction liquid remains). If a larger amount of the first ink is applied so as to enhance the color fastness to washing and rubbing of the first ink, cracks become likely to occur.

On the other hand, the second ink does not degrade the color fastness to washing of the resulting image. This is probably because the second ink comes in contact with the layer of the first ink, but not with the cloth. The second ink is however required to have a much higher color fastness to rubbing because the second ink defines the surface of the coating film and is, accordingly, likely to be directly touched for using the recorded article.

### SUMMARY

An advantage of some aspects of the invention is that it provides a recording method using a reaction liquid for improving image quality and capable of forming a recorded article superior in color fastness to washing and rubbing and in resistance to cracking, and an ink set used in the recording method.

The present inventors have conducted intensive research to solve the above issues and have found that the issues can be solved by specifying the resins of the polymer fine particles in the first and the second ink composition. Thus the invention has been accomplished.

Accordingly, the following subject matter is provided. An embodiment of the invention provides a recording method including depositing onto a recording region of a recording medium a reaction liquid containing a flocculant capable of forming an aggregate of at least one constituent in an ink composition or increasing the viscosity of the ink composition, depositing a first ink composition containing a coloring material, polymer fine particles made of a resin being an acrylic resin, and water onto the recording region on which the reaction liquid has been deposited, and depositing a second ink composition containing a coloring material, polymer fine particles made of a resin being a urethane resin, and water onto the recording region on which the first ink composition has been deposited.

The first ink composition may be deposited onto the recording region at a rate of 90 mg/inch² to 250 mg/inch², and the second ink composition may be deposited onto the recording region at a rate of 10 mg/inch² to 30 mg/inch².

The resin forming the polymer fine particles of the first ink composition may be an emulsifier-emulsifiable acrylic resin, and the resin forming the polymer fine particles of the second ink composition may be a self-emulsifiable urethane resin.

The recording medium may be cloth.

The content of polymer fine particle solids in the first ink composition may be 7% to 18% by mass relative to the total mass of the first ink composition, and the content of polymer fine particles solids in the second ink composition may be 2% to 7% by mass relative to the total mass of the second ink composition.

The first and the second ink composition may be deposited by an ink jet method.

The ratio of the polymer fine particle solids content in the first ink composition to the polymer fine particle solids content in the second ink composition may be 1 to 9 on a mass basis.

Preferably, the first ink composition is deposited onto the recording region in a state where the volatile component of the reaction liquid remains 40% by mass or more.

The first ink composition may be a white ink composition containing a white coloring material as the coloring material, and the second ink composition may be a color ink composition containing a non-white coloring material as the coloring material.

Another embodiment provides an ink set including the reaction liquid, the first ink composition, and the second ink composition that are used in the above-described recording method.

### BRIEF DESCRIPTION OF THE DRAWING

The invention will be described with reference to the accompanying drawing, wherein like numbers reference like elements.

FIGURE is a block diagram of the structure of a recording apparatus used in an embodiment of the invention.

### DESCRIPTION OF EXEMPLARY EMBODIMENTS

Exemplary embodiments of the invention will now be described in detail. The invention is not limited to the following embodiments, and various modifications may be made within the scope and spirit of the invention.

A recording method according to an embodiment of the invention includes depositing onto a recording region of a recording medium a reaction liquid containing a flocculant capable of forming an aggregate of at least one constituent in an ink composition or increasing the viscosity of the ink composition, depositing a first ink composition containing a coloring material, polymer fine particles made of a resin being an acrylic resin, and water onto the recording region on which the reaction liquid has been deposited, and depositing a second ink composition containing a coloring material, polymer fine particles made of a resin being a urethane resin, and water onto the recording region on which the first ink composition has been deposited.

The recording apparatus and recording medium used in the recording method will first be described before describing the recording method.

### 1. Recording Apparatus

FIGURE is a block diagram of the structure of a recording apparatus used in an embodiment of the invention. A printer driver is installed to a computer 130. The computer 130 outputs to a printer 1 printing data according to the image or pattern to be recorded so that the printer 1 can form the image or pattern. The printer 1 corresponds to the recording apparatus. The printer 1 includes an ink supply unit 10, a transport unit 20, a head unit 30, a drying unit 40, a maintenance unit 50, detectors 110, a memory device 123, an interface 121, and a controller 120. The controller 120 includes a CPU 122 and a unit control circuit 124. In the printer 1 that has received printing data from the computer 130 that is an external device, the controller 120 controls each unit of the printer 1 and recoding conditions for recording an image or a pattern on a recording medium according to the printing data. The internal conditions of the printer 1 are monitored by the detectors 110. The detectors 110 output detection results to the controller 120. The controller 120 controls each unit according to the detection results transmitted from the detectors 110 and causes the memory device 123 to store the printing data input through the interface 121. The memory device 123 also stores control information for controlling each unit. The drying unit 40 includes a heater or a blower and dries the compositions deposited on the recording medium, such as inks.

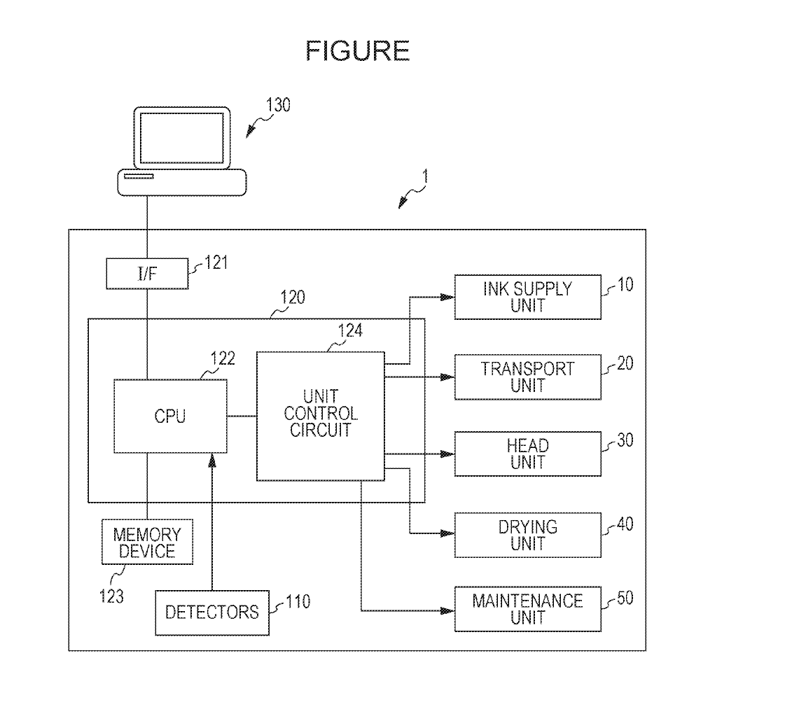

The head unit 30 of the recording apparatus (printer 1) includes heads (ink jet heads) from which a reaction liquid or an ink composition is ejected onto the recording medium for recording. The head has a cavity that allows a reaction liquid contained in a reaction liquid container or an ink composition contained in an ink container to be ejected through nozzles, an ejection driver provided for one cavity for applying driving forth to the ink, and nozzles provided for one cavity through which the ink composition is ejected outside the head, and a nozzle face on which the nozzles are formed. A plurality of sets of a cavity, and an ejection driver and nozzles provided for the cavity may be independently provided for one head. The ejection driver may include an electromechanical conversion element, such as a piezoelectric element, capable of varying the capacity of the cavity by mechanical deformation, or an electro-thermal conversion element capable of generating heat to form bubbles in the ink. The recording apparatus may have a plurality of heads, one or more for each color. If a plurality of heads are used for one color, the heads may be arranged in the width direction of the recording medium to define a line head. This structure increases the recording width. For recording using ink compositions of a plurality of colors, the recording apparatus has heads, one or more for each color. The head may have the structure as shown in FIGS. 3A and 3B disclosed in JP-A-2009-279830.

For a line printer that is a line recording apparatus, a line head is used as the head, which has a nozzle line length more than or equal to the width of the recording medium. The line head ejects an ink composition toward the recording medium while the line head and the recording medium move relative to each other in a direction intersecting with the width direction of the recording medium. Line head printers perform one-pass recording with the head fixed so as substantially not to move. Line printers are more advantageous than serial printers because of high recording speed.

The length of the “line head having a nozzle line length more than or equal to the width of the recording medium” need not be exactly the same as the width of the recording medium and may be different from the width of the recording medium. For example, the length of the line head may be equal to the width of the region of the recording medium to which ink compositions will be ejected (region in which an image or pattern will be recorded).

On the other hand, serial printers that are serial type recording apparatuses perform multi-pass (two or more passes) recording in such a manner that the head performs scanning (pass) for ejecting an ink composition while moving in a direction intersecting with the direction in which the recording medium moves.

### 2. Recording Medium

The recording medium is not particularly limited, but is preferably cloth. Examples of the cloth include, but are not limited to, fabric, knitting and nonwoven fabric made of natural fiber, such as that of silk, cotton, or sheep wool, or synthetic fiber, such as that of nylon, polyester, or rayon.

### 3. Reaction Liquid

The recording method according to an embodiment of the invention uses a reaction liquid (pretreatment liquid). The reaction liquid contains a flocculant capable of forming an aggregate of one or more constituents of the ink composition or increasing the viscosity of the ink composition.

The flocculant reacts with any of the constituents in the first ink composition, preferably with either the coloring material or the polymer fine particles, thereby aggregating the particles of the coloring material in the first ink composition. Thus the color developability of the image or pattern of the first ink composition is increased to satisfactorily cover the cloth.

Preferably, the flocculant is selected from the group consisting of polyvalent metal salts, organic acids, and cationic compounds. More preferably, any of the polyvalent metal salts and organic acids, still more preferably any one of the polyvalent metal salts, is used. The flocculant content in the reaction liquid is preferably 1% to 20% by mass. The lower limit of the flocculant content is preferably 2% by mass, more preferably 3% by mass, and still more preferably 5% by mass. The upper limit of the flocculant content is preferably 15% by mass, and more preferably 10% by mass.

Polyvalent metal salts are compounds made up of a divalent or higher-valent metal ion and an anion. Examples of the divalent or higher-valent metal ion include Ca²⁺, Me²⁺, Cu²⁺, Ni²⁺, Zn²⁺, and Ba²⁺. Examples of the anion include Cl⁻, NO₃⁻, CH₃COO⁻, I⁻, Br⁻, and ClO₃⁻. From the viewpoint of increasing aggregation performance, magnesium salts, calcium salts and aluminum salts are also useful.

The organic acid may be, but is not limited to, acetic acid, propionic acid, or lactic acid.

The cationic compound may be, but is not limited to, a water-soluble cationic polymer that will be positively charged in water, such as polyallylamine or a quaternary salt of polyallylamine.

The reaction liquid may contain a resin. The resin can be selected from, but not limited to, the known resins including acrylic resins, styrene-acrylic resins, fluorene resins, urethane resins, polyolefin resins, and ethylene-vinyl acetate resins.

The reaction liquid may contain other constituents, such as a surfactant, a sizing (for example, starch, cellulose-based material, polysaccharide, protein, water-soluble polymer, etc.), water, a pH adjuster, a preservative, and a fungicide.

### 4. Ink Set

The ink set according to an embodiment of the invention includes a first ink composition containing a coloring material, polymer fine particles made of a resin being an acrylic resin, and water, and a second ink composition containing a coloring material, polymer fine particles made of a resin being an urethane resin, and water. The ink set of the present embodiment may further include the above-described reaction liquid.

Each ink composition will be further described in detail.

### 4. 1. First Ink Composition

In the present embodiment, the first ink composition contains a coloring material, polymer fine particles made of a resin that is an acrylic resin, and water.

The first ink composition is intended to form an undercoat layer facilitating the deposition of the second ink composition. For example, if the hue of the second ink composition is close to the hue of the cloth, or if a cloth having a low lightness (such as black or dark blue cloth) is used, an image formed of the second ink composition on such a cloth can be less visible. In such a case, an undercoat layer is formed of a first ink composition having different hue from the second ink composition, thereby increasing the visibility of the image formed of the second ink composition on the undercoat layer. Accordingly, it is desirable that the first ink composition and the second ink composition have different hues or lightnesses from each other. For example, if recording is performed on a black cloth, using a color ink containing a color pigment (such as a yellow ink, a magenta ink, or a cyan ink) or a black ink containing a black pigment as the second ink composition, the resulting image of the second ink is less visible. In such a case, the visibility of the image of the second ink composition can be increased by forming a pattern (undercoat layer) of a first ink composition containing, for example, a white pigment on the cloth.

Alternatively, the undercoat layer may be formed for increasing the adhesion, color developability or any other property of the image of the second ink composition. In these instances, the first ink composition used for forming the undercoat layer may be what is called a clear ink containing no or a small amount (0.1% by mass or less) of coloring material, and the first ink composition and the second ink composition need not have different hues or lightnesses from each other.

The constituents of the first ink composition will be described in detail below.

### 4. 1. 1. Coloring Material

The coloring material in the first ink composition is a dye or a pigment. Pigments are superior in color developability and advantageous for forming an aggregate or increasing viscosity by the reaction liquid. The pigment may be an inorganic pigment or an organic pigment. The coloring material of the first ink composition may be selected from both white coloring materials and non-white coloring materials as long as the first ink composition has a different hue from the second ink composition.

Although the first ink composition may contain a coloring material of any color, the first ink composition used for recording on a cloth having a low lightness preferably contains a white coloring material. Such a first ink composition increases the visibility of the image formed of the second ink composition on the coating of the first ink composition.

Examples of the white coloring material includes, but are not limited to, inorganic white pigments, such as titanium oxide, zinc oxide, zinc sulfide, antimony oxide, and zirconium oxide. In addition to these inorganic white pigments, organic white pigments may be used such as white hollow resin particles and polymer particles. White dyes may be used.

White pigments designated by color index (C.I.) numbers include, but are not limited to, C.I. Pigment Whites (basic lead carbonate), 4 (zinc oxide), 5 (mixture of zinc sulfide and barium sulfate), 6 (titanium oxide), 6:1 (titanium oxide containing other metal oxides), 7 (zinc sulfide), 18 (calcium carbonate), 19 (clay), 20 (titanated mica), 21 (barium sulfate), 22 (natural barium sulfate), 23 (gloss white), 24 (alumina white), 25 (gypsum), 26 (magnesium oxide-silicon oxide), 27 (silica), and 28 (anhydrous calcium silicate). Among those, titanium oxide is preferred because it is superior in color developability, hiding power and visibility (lightness), and because the dispersion thereof has a suitable particle size.

Preferably, titanium oxide is of rutile type, which is a typical white pigment. The rutile-type titanium oxide may be prepared in a laboratory, or obtained from commercially available products. For preparing the rutile-type titanium oxide (powder) in a laboratory, a known sulfate method or chloride method can be applied. Commercially available products of rutile-type titanium oxide include Tipaque (registered trademark) series CR-60-2, CR-67, R-980, R-780, R-850, R-980, R-630, R-670, and PF-736 (each product name of Ishihara Sangyo Kaisha, Ltd.)

Non-white pigments, which are pigments other than white pigments, may be used. Exemplary non-white pigments include, but are not limited to, organic pigments deriving from, for example, azo compounds, phthalocyanine, dyes, condensed polycyclic compounds, and nitro and nitroso compounds (such as Brilliant Carmine 6B, Lake Red C, watching red, disazo yellow, Hansa Yellow, phthalocyanine blue, phthalocyanine green, alkali blue, and aniline black); metals, such as cobalt, iron, chromium, copper, zinc, lead, titanium, vanadium, manganese and nickel, and oxides or sulfides thereof; carbon blacks (C.I. Pigment Black 7), such as furnace carbon black, lampblack, acetylene black and channel black; and other inorganic pigments such as ocher, ultramarine blue and Prussian blue.

More specifically, exemplary carbon blacks that can be used as the black pigment include MCF 88, No. 2300, No. 2200B, No. 900, No. 33, No. 40, No. 45, No. 52, MA 7, MA 8, and MA 100 (each code name of products manufactured by Mitsubishi Chemical); Raven series 5750, 5250, 5000, 3500, 1255, and 700 (each code name of products manufactured by Columbian Carbon); Regal series 400R, 330R and 660R, Mogul L, and Monarch series 700, 800, 880, 900, 1000, 1100, 1300 and 1400 (each product name manufactured by Cabot); Color Blacks FW1, FW2, FW2V, FW18, FW200 5150, 5160, 5170, Printex series 35, U, V and 140U, and Special Blacks 6, 5, 4A and 4 (each product name manufactured by Degussa).

Exemplary yellow pigments include C.I. Pigment Yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Exemplary magenta pigments include C.I. Pigment Reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violets 19, 23, 32, 33, 36, 38, 43, and 50.

Exemplary cyan pigments include C.I. Pigment Blues 1, 2, 3, 15, 15:1, 15:2, 15:3, 15:34, 15:4, 16, 18, 22, 25, 60, 65, and 66.

Pigments other than the magenta, cyan and yellow pigments include C.I. Pigment Greens 7 and 10, C.I. Pigment Browns 3, 5, 25 and 26, and C.I. Pigment Oranges 1, 2, 5, 7, 13, 14, 15, 16, 24, 34, 36, 38, 40, 43 and 63.

The above-cited pigments may be used singly or in combination.

Although the pigment content in the first ink composition depends on the pigment, it is preferably in the range of 1% to 30% by mass, more preferably 5% to 15% by mass, and still more preferably 5% to 12% by mass, relative to the total mass of the first ink composition from the viewpoint of ensuring a good color developability. If titanium oxide is used as the pigment of the first ink composition, the content thereof is preferably 3% to 25% by mass, more preferably 5% to 20% by mass, relative to the total mass of the first ink composition because titanium oxide does not easily settle and helps the ink composition exhibit high hiding power and color reproduction (particularly on a cloth having a low lightness).

The particles of the pigment may be surface-treated or the pigment may contain a dispersant, from the viewpoint of increasing the dispersibility of the pigment.

The pigment whose particles are surface-treated (hereinafter referred to as surface-treated pigment) is a pigment dispersible in water, having hydrophilic groups, such as carboxy or sulfonate groups, directly or indirectly bound to the surfaces thereof by physical treatment or chemical treatment. This surface-treated pigment may be referred to as self-dispersible pigment.

The pigment containing a dispersant is a pigment in the form of a dispersion in which the pigment particles are dispersed with a surfactant or a resin acting as the dispersant. Such a pigment may be referred to as polymer-dispersed pigment. The surfactant or the resin can be selected from among known substances. The polymer-dispersed pigment includes a pigment whose particles are coated with a resin Such a resin-coated pigment can be prepared by, for example, acid precipitation, phase inversion emulsification, or miniemulsion polymerization.

### 4. 1. 2. Polymer Fine Particles

The first ink composition contains polymer fine particles made of a resin that is an acrylic resin.

The resin contained in the first ink composition is in the form of polymer fine particles (emulsion) from the viewpoint of increasing the adhesion and color fastness to rubbing of the coating film of the first ink composition and the storage stability of the first ink composition. In the present embodiment, the first ink composition contains an acrylic resin as the resin forming the polymer fine particles, consequently exhibiting such a ductility that the coating film can expand or contract following the expansion or contraction of the cloth. The acrylic resin thus prevents the ink coating film from being broken or cracked and ensures a satisfactory color fastness to washing and rubbing of the resulting image.

The acrylic resin used as the resin forming the polymer fine particles in the first ink composition is preferably an emulsifier-emulsifiable acrylic resin that can be made water-dispersible by using an external emulsifier. The first ink composition comes into direct contact with the reaction liquid. If a self-emulsifiable acrylic resin is used, the reaction liquid causes the self-emulsifiable acrylic resin to separate from the liquid component of the ink composition in an early stage. Consequently, the adhesion of the ink coating film to the cloth tend to be degraded. Accordingly an emulsifier-emulsifiable resin is advantageous for minimizing the degradation of the adhesion due to the presence of the reaction liquid.

The acrylic resin in the first ink composition preferably has a glass transition temperature (Tg) of 0° C. or less, more preferably −10° C. or less, still more preferably −20° C. or less. Such an acrylic resin can prevent the ink coating film from being broken or cracked and ensure satisfactory washing fastness and rub fastness. Also, the lower limit of the glass transition temperature (Tg) is preferably −60° C. and more preferably −50° C.

The acrylic resin contains at least a (meth)acrylic monomer, and, preferably, the (meth)acrylic monomer accounts for 20% by mass or more of the total mass of the monomers forming the acrylic resin. More preferably, the proportion of the (meth)acrylic monomer is 40% by mass or more, such as 50% by mass or more, 70% by mass or more, or 80% by mass or more. The (meth)acrylic monomer may be (meth)acrylic acid or a (meth)acrylate. Examples of the (meth)acrylate include alkyl (meth)acrylates, alicyclic alkyl (meth)acrylates, and aromatic (meth)acrylates. Examples of commercially available acrylic resins include, but are not limited to, Mowinyl 7320 (product name, produced by Nippon Synthetic Chemical Industry Co., Ltd.); Micro Gel E-1002 and Micro Gel E-5002 (each product name, produced by Nippon Paint Co., Ltd.); VONCOAT 4001 and VONCOAT 5454 (each product name, produced by DIC); SAE 1014 (product name, produced by Zeon Corporation); Saivinol SK-200 (product name, produced by Saiden Chemical Industry Co., Ltd.); JONCRYL 7100, JONCRYL 390, JONCRYL 711, JONCRYL 511, JONCRYL 7001, JONCRYL 632, JONCRYL 741, JONCRYL 450, JONCRYL 840, JONCRYL 62J, JONCRYL 74J, JONCRYL HRC-1645J, JONCRYL 734, JONCRYL 852, JONCRYL 7600, JONCRYL 775, JONCRYL 537J, JONCRYL 1535, JONCRYL PDX-7630A, JONCRYL 352J, JONCRYL 352D, JONCRYL PDX-7145, JONCRYL 538J, JONCRYL 7640, JONCRYL 7641, JONCRYL 631, JONCRYL 790, JONCRYL 780 and JONCRYL 7610 (each product name, produced by BASF); and NK Binder R-5HN (product name, product of Shin-Nakamura Chemical, solid content: 44%).

The content of polymer fine particle solids in the first ink composition is preferably in the range of 6% by mass to 19% by mass, more preferably in the range of 7% by mass to 18% by mass, relative to the total mass of the first ink composition. When the content of polymer fine particle solids is in such a range, particularly not less than the lower limit, the polymer fine particles can satisfactorily increase the adhesion of the ink composition even though the reaction liquid is used. Consequently, the color fastness to washing and rubbing of the resulting image are increased. In the present embodiment, since the first ink composition contains an acrylic resin as the resin forming the polymer fine particles, the coating thereof can be prevented from cracking even if the polymer fine particle solids content is increased. In addition, when the polymer fine particle solids content is not more than the upper limit, the resin particles are unlikely to aggregate. Consequently, the first ink composition can be stably stored and stably ejected.

### 4. 1. 3. Other Constituents

The first ink composition contains water and may optionally contain an organic solvent and a surfactant. Water

The water is a major medium of the ink and will be evaporated by being dried. The water may be pure water or ultra-pure water from which ionic impurities have been removed as much as possible. Examples of such water include ion exchanged water, ultrafiltered water, reverse osmosis water, and distilled water. Sterile water prepared by, for example, UV irradiation or addition of hydrogen peroxide can prevent the occurrence of mold or bacteria in the ink stored for a long time. The water content in the first ink composition may be, but is not limited to, 50% by mass or more, more preferably in the range of 50% to 95% by mass, relative to the total mass of the first ink composition.

### Water-Soluble Organic Solvent

The first ink composition may further contain a water-soluble organic solvent. The water-soluble organic solvent tends to reduce the amount of the reaction liquid remaining on the portion on which the reaction liquid has been deposited. Examples of the water-soluble organic solvent include, but are not limited to, alcohols or glycols, such as glycerin, ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, 1,6-hexanediol, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol monobutyl ether, diethylene glycol mono-t-butyl ether, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, dipropylene glycol mono-iso-propyl ether, diethylene glycol dimethyl ether, diethylene glycol diethyl ether, diethylene glycol dibutyl ether, diethylene glycol ethylmethyl ether, diethylene glycol butylmethyl ether, triethylene glycol dimethyl ether, tetraethylene glycol dimethyl ether, dipropylene glycol dimethyl ether, dipropylene glycol diethyl ether, tripropylene glycol dimethyl ether, methanol, ethanol, n-propyl alcohol, iso-propyl alcohol, n-butanol, 2-butanol, tert-butanol, iso-butanol, n-pentanol, 2-pentanol, 3-pentanol, and tert-pentanol; and N,N-dimethylformamide, N,N-dimethylacetamide, 2-pyrrolidone, N-methyl-2-pyrrolidone, 2-oxazolidone, 1,3-dimethyl-2-imidazolidinone, dimethyl sulfoxide, sulfolane, and 1,1,3,3-tetramethyl urea. Among these, 1,2-hexanediol and propylene glycol are advantageous.

The content of the water-soluble organic solvent is preferably 7.5% to 22.5% by mass, more preferably 10% to 20% by mass, and still more preferably 12.5% to 17.5% by mass. Surfactant

The surfactant can reduce the surface tension to increase the wettability of the ink composition on the recording medium. Among surfactants, preferred are acetylene glycol-based surfactants, silicone surfactants, and fluorosurfactants.

Exemplary acetylene glycol-based surfactants include, but are not limited to, SURFYNOL series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA and DF110D (each product name, produced by Air Products and Chemicals Inc.); OLFINE series B, Y, P, A, STG, SPC, E1004, E1010, PD-001, PD-002W, PD-003, PD-004, EXP. 4001, EXP. 4036, EXP. 4051, AF-103, AF-104, AK-02, SK-14 and AE-3 (each product name, produced by Nissin Chemical Industry); and ACETYLENOL series E00, E00P, E40 and E100 (each product name, produced by Kawaken Fine Chemicals).

Exemplary silicone surfactants include, but are not limited to, polysiloxane-based compounds. For example, a polyether-modified organosiloxane may be used as a polysiloxane-based compound. Polyether-modified organosiloxanes are available from the market, such as BYK-306, BYK-307, BYK-333, BYK-341, BYK-345, BYK-346, and BYK-348 (each product name, produced by BYK); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (each product name, produced by Shin-Etsu Chemical).

An example of preferred fluorosurfactants may be a fluorine-modified polymer, such as BYK-340 (produced by BYK).

### Other Constituents

The first ink composition may further contain other additives, as required, such as a solubilizing agent, a viscosity modifier, a pH adjuster, an antioxidant, a preservative, an antifungal agent, a corrosion inhibitor, and a chelating agent for trapping metal ions affecting dispersion.

### 4. 2. Second Ink Composition

The second ink composition of the ink set of the present embodiment contains a coloring material, polymer fine particles made of a resin that is a urethane resin, and water.

The second ink composition is deposited onto the image or coating film formed with the first ink composition, so that the visibility of the resulting image is increased.

The constituents of the second ink composition will be described in detail below.

### 4. 2. 1. Coloring Material

The coloring material in the second ink composition is a dye or a pigment. Pigments are superior in color developability and advantageous for forming an aggregate or increasing viscosity by the reaction liquid. The pigment may be an inorganic pigment or an organic pigment. The pigment contained in the second ink composition may be either a white pigment or a pigment other than the white pigments, as long as it has a different hue from the first ink composition.

Either pigment may be used in the second ink composition. For recording on a cloth having a low lightness, however, a white pigment is used in the first ink composition, and a color pigment other than white pigments is used in the second ink composition. Such a combination of the ink compositions enables the image formed of the second ink composition to be more visible even on a cloth having a low lightness.

Examples of the pigment that can be used in the second ink composition are the same as those of the first ink composition and thus description thereof are omitted. The pigment in the second ink composition is preferably a color pigment, such as an organic color pigment, or a black pigment, such as carbon black.

Although the pigment content in the second ink composition depends on the pigment, it is preferably in the range of 0.1% to 15% by mass, more preferably 1% to 15% by mass, and still more preferably 1% to 10% by mass, relative to the total mass of the second ink composition from the viewpoint of ensuring a good color developability.

### 4. 2. 2. Polymer Particles

The second ink composition contains polymer fine particles made of a resin that is a urethane resin.

The resin contained in the second ink composition is in the form of polymer fine particles (emulsion) from the viewpoint of increasing the adhesion and color fastness to rubbing of the coating film of the second ink composition and the storage stability of the second ink composition. In the present embodiment, since the second ink composition contains a urethane resin as the resin forming the polymer fine particles, a satisfactory color fastness to washing and rubbing can be ensured.

The urethane resin used as the resin forming the polymer fine particles in the second ink composition is preferably a self-emulsifiable urethane resin to which a hydrophilic component required for stably dispersing the polymer fine particles in water is introduced. By using such a self-emulsifiable urethane resin, the other constituents of the second ink composition can be unreactive. This is advantageous for increasing the degree of freedom in selecting the other constituents. In addition, since the second ink composition is not much affected by the reaction liquid, the detrimental effect of the reaction liquid is small even though a self-emulsifiable urethane resin is used.

The urethane resin in the second ink composition preferably has a glass transition temperature (Tg) of 0° C. or less, more preferably −10° C. or less, still more preferably −20° C. or less. Such a urethane resin can prevent the coating film of the ink composition from being broken or cracked and ensure a satisfactory color fastness to washing and rubbing. Also, the lower limit of the glass transition temperature (Tg) is preferably −60° C. and more preferably −50° C.

A urethane resin has a skeleton having at least a urethane bond. The urethane resin used in the present embodiment preferably has at least one of a polyether skeleton, a polycarbonate skeleton and a polyester skeleton. More preferably, the urethane resin has either or both a polyester skeleton and a polycarbonate skeleton in view of color fastness to washing and rubbing and storage stability. The urethane resin may be used in the form of a resin emulsion. Preferred examples of the urethane resin emulsion include, but are not limited to, Sancure 2710 (product name, produced by The Lubrizol Corporation), Permarin UA-150 (product name, produced by Sanyo Chemical Industries, Ltd.), Superflex series 460, 470, 610 and 700 (each product name, produced by Dai-ichi Kogyo Seiyaku Co., Ltd.), NeoRez series R-9660, R-9637 and R-940 (each product name, produced by Kusumoto Chemicals, Ltd.), Adeka Bon-Tighter HUX-380 and Adeka Bon-Tighter 290K (each product name, produced by Adeka), Takelac (registered trademark) series W-605, W-635 and WS-6021 (each product name, produced by Mitsui Chemicals, Inc.), and Polyether (Tg=20° C.) produced by Taisei Fine Chemical Co., Ltd.

The content of polymer fine particle solids in the second ink composition is preferably in the range of 2% by mass to 7% by mass relative to the total mass of the second ink composition. In the present embodiment, the presence of the urethane resin contained as the polymer fine particles in the second ink composition ensures a satisfactory color fastness to washing and rubbing even though the polymer fine particle solids content is reduced. Also, since the second ink composition is deposited onto the coating of the first ink composition, the second ink composition can exhibit a satisfactory adhesion even though the polymer fine particle solids content is low. Furthermore, since the polymer fine particle solids content can therefore be reduced, cracks in the resulting image can be prevented.

The ratio of the polymer fine particle solids content in the first ink composition to the polymer fine particle solids content in the second ink composition may be 1 to 9 on a mass basis. By setting the proportion of the contents of the polymer fine particle solids in the first ink and the second ink composition in this range, the resulting image can exhibit a satisfactory color fastness to rubbing and washing.

### 4. 2. 3. Other Constituents

The second ink composition contains water and may optionally contain an organic solvent, a surfactant, a pH adjuster, a preservative, a fungicide, and so forth. These constituents may be the same as those described for the first ink composition, the contents thereof may also be the same, and thus description thereof is omitted.

### 4. 3. Preparation

The inks included in the ink set of the present embodiment (the first ink composition and the second ink composition) can be prepared by mixing the above-described constituents in an arbitrary order and optionally removing impurities by, for example, filtration. For mixing the constituents, it may be suitable to add the constituents one after another into a container equipped with a stirrer, such as a mechanical stirrer or a magnetic stirrer, and stir the contents of the container. Filtration may be performed as required by, for example, centrifugal filtration or using a filter paper.

### 4. 4. Physical Properties

Preferably, each ink composition of the ink set according to the present embodiment has a surface tension at 20° C. in the range of 20 mN/m to 40 mN/m, more preferably in the range of 25 mN/m to 35 mN/m, from the viewpoint of the balance between the resulting image quality and the reliability of the ink composition as textile printing ink. The surface tension of an ink composition can be obtained by measuring the ink composition wetting a platinum plate at 20° C. with, for example, an automatic surface tensiometer CBVP-Z (manufactured by Kyowa Interface Science).

Also, each ink composition of the ink set preferably has a viscosity at 20° C. in the range of 3 mPa·s to 10 mPa·s, more preferably 3 mPa·s to 8 mPa·s, from the same viewpoint. The viscosity of the ink compositions can be measured at 20° C. with a viscoelasticity meter MCR-300 (manufactured by Pysica).

### 5. Recording Method

A recording method according to an embodiment of the invention is performed using the above-described ink set. The method includes depositing onto a recording region of a recording medium a reaction liquid containing a flocculant capable of forming an aggregate of at least one constituent in an ink composition or increasing the viscosity of the ink composition, depositing a first ink composition containing a coloring material, polymer fine particles made of a resin being an acrylic resin, and water on the recording region on which the reaction liquid has been deposited, and depositing a second ink composition containing a coloring material, polymer fine particles made of a resin being a urethane resin, and water on the recording region on which the first ink composition has been deposited.

Preferably, the recording method is performed by an ink jet method using an ink jet recording apparatus charged with the ink compositions of the above-described ink set. The ink jet recording apparatus may be, but is not limited to, of drop-on-demand type. The drop-on-demand ink jet recording apparatus may adopt any of the ink jet recording techniques including a piezoelectric technique using piezoelectric elements disposed in a recording head and a thermal jet technique using heaters of heat resistors disposed in a recording head.

The process steps of the recording method will now be described in detail.

### 5. 1. Depositing Reaction Liquid

The recording method of the present embodiment includes depositing a reaction liquid. In this step, a reaction liquid containing a flocculant capable of forming an aggregate of at least one constituent in an ink composition or increasing the viscosity of the ink composition is deposited onto a recording region of a recording medium. The constituent that can react with the flocculant may be the above-described pigment or resin particles.

The flocculant reacts with the resin or other constituents in the first ink composition, thereby aggregating the particles of the pigment in the first ink composition. Thus the color developability of the image or pattern of the first ink composition is increased, thereby satisfactorily covering the cloth.

The deposition of the reaction liquid may be performed by immersing a cloth in the reaction liquid or spraying the reaction liquid onto the cloth. Alternatively, if the ink set includes the reaction liquid, the reaction liquid may be applied with an ink jet recording apparatus.

Preferably, the amount of the reaction liquid to be deposited onto the recording region is 2 mg/inch² to 20 mg/inch². The lower limit of the amount to be deposited is preferably 5 mg/inch², and the upper limit thereof is preferably 15 mg/inch², and more preferably 10 mg/inch². When the reaction liquid is deposited at a rate of 2 mg/inch² or more, unevenness tends to decrease. Also, when the reaction liquid is deposited at a rate of 20 mg/inch² or less, adhesion becomes unlikely to decrease.

### 5. 2. Depositing First Ink Composition

In the step of depositing a first ink composition, the above-described first ink composition is deposited onto a cloth to form a layer (image) of the first ink composition. Preferably, the deposition of the first ink composition is performed with an ink jet recording apparatus. Although the layer of the first ink composition is used as the undercoat layer (background image) of the second ink composition, the second ink composition is not necessarily applied over the entire surface of the first ink composition layer.

Preferably, the first ink composition is deposited onto the cloth at a deposition rate of 90 mg/inch² to 250 mg/inch². When the first ink composition is deposited at a rate of 90 mg/inch² or more, the resulting image exhibit a high hiding power and an increased color fastness to washing and rubbing. In general, a larger amount of ink deposited, in general, causes the image to crack. In the first ink composition, on the other hand, the acrylic resin forming the polymer fine particles can reduce the occurrence of cracks in the image. When the first ink composition is deposited at a rate of 250 mg/inch² or less, the coating of the first ink composition exhibits a satisfactory hiding power, and the first ink composition can be saved.

The rate of the deposition amount of the first ink composition can be estimated by dividing the total weight (mg) of the first ink composition deposited in the step of depositing the first ink composition by the area (inch²) of the undercoat layer formed of the first ink composition.

In the present embodiment, it is advantageous to employ wet-on-wet technique in which the first ink composition is deposited onto the reaction liquid without drying the reaction liquid. More specifically, the first ink composition is deposited onto the recording region in a state where the volatile component of the reaction liquid remains 40% by mass or more. The wet-on-wet technique is advantageous for shortening printing time by the time required for drying the reaction liquid. Since the wet-on-wet technique, in general, uses a larger amount of water on the recording medium or cloth. The aggregation of the constituents in the ink does not occur on the fibers of the cloth, but is likely to occur in the water on the cloth, apart from the fibers. This can disadvantageously reduce adhesion. Accordingly, in the present embodiment, the decrease in adhesion is suppressed by controlling the amount of the first ink composition to be deposited to 90 mg/inch² or more.

The value of the remaining volatile component in the reaction liquid is the percentage of the mass (mass B) of the volatile component in the layer of the reaction liquid at the lime immediately before depositing the first ink composition to the mass (mass A) of the volatile component in the reaction liquid used for pretreatment. Mass A can be estimated by subtracting the mass of the reaction liquid from which the volatile component has been completely removed by drying from the total mass of the reaction liquid applied onto the cloth. Mass B can be estimated by subtracting the mass of the reaction liquid from which the volatile component has been completely removed by drying from the mass of the reaction liquid at the time immediately before depositing the first ink composition.

From the viewpoint of enabling the above percentage or more of the volatile component of the reaction liquid to remain, it is preferable that the first ink composition be deposited within 90 seconds after the deposition of the reaction liquid without having a time to heat the cloth for drying the reaction liquid between the steps of depositing the reaction liquid and the step of depositing the first ink composition.

### 5. 3. Depositing Second Ink Composition

In the step of depositing a second ink composition, the above-described second ink composition is deposited onto the layer of the first ink composition to form an image of the second ink composition. Thus the visibility of the image of the second ink composition is increased. Preferably, the deposition of the second ink composition is performed with an ink jet recording apparatus.

Preferably, the second ink composition is deposited onto the recording region on the cloth at a deposition rate of 10 mg/inch² to 30 mg/inch². Since the image of the second ink composition is formed on the layer of the first ink composition, the image of the second ink composition can adhere satisfactorily to the undercoat layer formed of the first ink composition as long as the first ink composition is deposited at a rate of 10 mg/inch² or more. In addition, in the present embodiment, the second ink composition contains a urethane resin as the resin forming the polymer particles. This enables the resulting image to exhibit a satisfactory color fastness to washing and rubbing even though the amount of the second ink composition that has been deposited is as small as about 10 mg/inch². Also, when the second ink composition is deposited at a rate of 30 mg/inch² or less, the image of the second ink composition is prevented from cracking.

The rate of the deposition amount of the second ink composition can be estimated by dividing the total weight (mg) of the second ink composition deposited in the step of depositing the second ink composition by the area (inch²) of the image formed of the second ink composition.

### 5. 4. Heating

The recording method of the present embodiment may further include heating the cloth after the step of depositing the second ink composition. Hence, this heating is intended to dry the undercoat layer formed on the cloth and the image overlying the undercoat layer. Since this heating helps the resins in the ink compositions form the respective coating films, the resulting image can exhibit a satisfactory color fastness to washing and rubbing.

The heating may be performed by, but not limited to, heat pressing, normal-pressure steaming, high-pressure steaming, or thermal fixing. The heat source for the heating may be, but is not limited to, infrared rays (lamp). The heating temperature can be a level at which the resins in the ink compositions can be fused, and at which the water in the ink compositions can be evaporated. The heating temperature is, for example, about 150° C. to 200° C.

After the heating, the printed cloth may be washed and dried. At this time, soaping treatment, that is, washing out the unfixed pigment with a heat soap solution, may be performed, if necessary.

### EXAMPLES

The above-described embodiments of the invention will now be further described in detail with reference to Examples. However, the invention is not limited to the Examples.

### Preparation of Reaction Liquid

Reaction liquids were prepared by mixing the constituents shown in Table 1.

TABLE 1

| | | No. 1 | No. 2 |
|---|---|---|---|
| Reaction liquid | Calcium chloride | 7 | |
| | Acetic acid | | 4 |
| | BYK348 | 0.5 | 0.5 |
| | Ion-exchanged water | Balance | Balance |
| | Total | 100 | 100 |

### Preparation of First and Second Ink Compositions

First ink compositions (white inks) and second ink compositions (color inks) were prepared by mixing the constituents shown in Table 2. The acrylic resins used were each an emulsifier-emulsifiable acrylic resin, and the urethane resin was a self-emulsifiable urethane resin.

TABLE 2

| | | | Example | | | | | | | | |
|---|---|---|---|---|---|---|---|---|---|---|---|
| | | Resin Tg | 1 | 2 | 3 | 4 | 5 | 6 | 7 | 8 | 9 |
| Reaction liquid | | (° C.) | No. 1 | No. 1 | No. 1 | No. 1 | No. 1 | No. 1 | No. 1 | No. 1 | No. 1 |
| First ink | White pigment content | | 8 | 8 | 8 | 8 | 8 | 8 | 8 | 8 | 8 |
| White ink | Acrylic resin solids | −17 | 10 | 7 | 18 | 10 | 10 | 10 | 6 | 7 | 19 |
| | (NK Binder R-5HN) | | | | | | | | | | |
| | Acrylic resin solids | −20 | | | | | | | | | |
| | (Mowinyl 7320) | | | | | | | | | | |
| | Urethane resin solids | −60 | | | | | | | | | |
| | (Takelac W6021) | | | | | | | | | | |
| | 2-Pyrrolidone | | 2 | 2 | 2 | 2 | 2 | 2 | 2 | 2 | 2 |
| | Glycerin | | 10 | 10 | 10 | 10 | 10 | 10 | 10 | 10 | 10 |
| | Triethylene glycol | | 1 | 1 | 1 | 1 | 1 | 1 | 1 | 1 | 1 |
| | Triethylene glycol monobutyl ether | | 1 | 1 | 1 | 1 | 1 | 1 | 1 | 1 | 1 |
| | BYK-348 | | 0.3 | 0.3 | 0.3 | 0.3 | 0.3 | 0.3 | 0.3 | 0.3 | 0.3 |
| | Ion-exchanged water | | Balance | Balance | Balance | Balance | Balance | Balance | Balance | Balance | Balance |
| | Total | | 100 | 100 | 100 | 100 | 100 | 100 | 100 | 100 | 100 |
| Second | Yellow pigment content | | | | | 3 | | | | | |
| ink | Magenta pigment content | | 3 | 3 | 3 | | | | 3 | 3 | 3 |
| Color ink | Cyan pigment content | | | | | | 3 | | | | |
| | Black pigment content | | | | | | | 3 | | | |
| | Acrylic resin solids | −17 | | | | | | | | | |
| | (NK Binder R-5HN) | | | | | | | | | | |
| | Urethane resin solids | −60 | 4 | 7 | 2 | 4 | 4 | 4 | 6 | 8 | 2.1 |
| | (Takelac W6021) | | | | | | | | | | |
| | Urethane resin solids | −31 | | | | | | | | | |
| | (Superflex S470) | | | | | | | | | | |

| | | | | | | | | | |
|---|---|---|---|---|---|---|---|---|---|
| 2-Pyrrolidone | 2 | 2 | 2 | 2 | 2 | 2 | 2 | 2 | 2 |
| Glycerin | 10 | 10 | 10 | 10 | 10 | 10 | 10 | 10 | 10 |
| Triethylene glycol | 1 | 1 | 1 | 1 | 1 | 1 | 1 | 1 | 1 |
| Triethylene glycol monobutyl ether | 1 | 1 | 1 | 1 | 1 | 1 | 1 | 1 | 1 |
| BYK-348 | 0.3 | 0.3 | 0.3 | 0.3 | 0.3 | 0.3 | 0.3 | 0.3 | 0.3 |
| Ion-exchanged water | Balance | Balance | Balance | Balance | Balance | Balance | Balance | Balance | Balance |
| Total | 100 | 100 | 100 | 100 | 100 | 100 | 100 | 100 | 100 |

| | | | | | | | | | |
|---|---|---|---|---|---|---|---|---|---|
| Resin (First ink)/Resin (Second ink) | 2.5 | 1.0 | 9.0 | 2.5 | 2.5 | 2.5 | 1.0 | 0.9 | 9.0 |
| Image quality | Good | Good | Good | Good | Good | Good | Good | Good | Good |
| Color fastness to washing | Excel- | Good | Good | Excel- | Excel- | Excel- | Fair | Good | Excel- |
| | lent | | | lent | lent | lent | | | lent |
| Color fastness to rubbing | Excel- | Good | Good | Excel- | Excel- | Excel- | Fair | Good | Excel- |
| | lent | | | lent | lent | lent | | | lent |
| Head reliability (White) | Excel- | Excel- | Good | Excel- | Excel- | Excel- | Excel- | Excel- | Fair |
| | lent | lent | | lent | lent | lent | lent | lent | |
| Head reliability (Color) | Excel- | Good | Excel- | Excel- | Excel- | Excel- | Excel- | Fair | Excel- |
| | lent | | lent | lent | lent | lent | lent | | lent |
| Cracking resistance | Good | Good | Good | Good | Good | Good | Good | Good | Good |

| | | | Example | | | | Comparative Example | | |
|---|---|---|---|---|---|---|---|---|---|
| | | Resin Tg | 10 | 2 | 12 | 13 | 1 | 2 | 3 |
| Reaction liquid | | (° C.) | No. 1 | No. 2 | No. 1 | No. 1 | No. 1 | No. 1 | None |
| First ink | White pigment content | | 8 | 8 | 8 | 8 | 8 | 8 | 8 |
| White ink | Acrylic resin solids | −17 | 18 | 7 | | 7 | | 10 | 6 |
| | (NK Binder R-5HN) | | | | | | | | |
| | Acrylic resin solids | −20 | | | 7 | | | | |
| | (Mowinyl 7320) | | | | | | | | |
| | Urethane resin solids | −60 | | | | | 10 | | |
| | (Takelac W6021) | | | | | | | | |

| | | | | | | | | |
|---|---|---|---|---|---|---|---|---|
| | 2-Pyrrolidone | 2 | 2 | 2 | 2 | 2 | 2 | 2 |
| | Glycerin | 10 | 10 | 10 | 10 | 10 | 10 | 10 |
| | Triethylene glycol | 1 | 1 | 1 | 1 | 1 | 1 | 1 |
| | Triethylene glycol monobutyl ether | 1 | 1 | 1 | 1 | 1 | 1 | 1 |
| | BYK-348 | 0.3 | 0.3 | 0.3 | 0.3 | 0.3 | 0.3 | 0.3 |
| | Ion-exchanged water | Balance | Balance | Balance | Balance | Balance | Balance | Balance |
| | Total | 100 | 100 | 100 | 100 | 100 | 100 | 100 |
| Second | Yellow pigment content | | | | | | | |
| ink | Magenta pigment content | 3 | 3 | 3 | 3 | 3 | 3 | 3 |
| Color ink | Cyan pigment content | | | | | | | |
| | Black pigment content | | | | | | | |

| | | | | | | | | |
|---|---|---|---|---|---|---|---|---|
| Acrylic resin solids | −17 | | | | | | 4 | |
| (NK Binder R-5HN) | | | | | | | | |
| Urethane resin solids | −60 | 1.8 | 7 | 7 | | 4 | | 6 |
| (Takelac W6021) | | | | | | | | |
| Urethane resin solids | −31 | | | | 7 | | | |
| (Superflex S470) | | | | | | | | |

| | | | | | | | |
|---|---|---|---|---|---|---|---|
| 2-Pyrrolidone | 2 | 2 | 2 | 2 | 2 | 2 | 2 |
| Glycerin | 10 | 10 | 10 | 10 | 10 | 10 | 10 |
| Triethylene glycol | 1 | 1 | 1 | 1 | 1 | 1 | 1 |
| Triethylene glycol monobutyl ether | 1 | 1 | 1 | 1 | 1 | 1 | 1 |
| BYK-348 | 0.3 | 0.3 | 0.3 | 0.3 | 0.3 | 0.3 | 0.3 |
| Ion-exchanged water | Balance | Balance | Balance | Balance | Balance | Balance | Balance |
| Total | 100 | 100 | 100 | 100 | 100 | 100 | 100 |

| | | | | | | | |
|---|---|---|---|---|---|---|---|
| Resin (First ink)/Resin (Second ink) | 10.0 | 1.0 | 1.0 | 1.0 | 2.5 | 2.5 | 1.0 |
| Image quality | Good | Fair | Good | Good | Good | Good | Bad |
| Color fastness to washing | Fair | Excel- | Excel- | Good | Excel- | Bad | Good |
| | | lent | lent | | lent | | |
| Color fastness to rubbing | Fair | Excel- | Good | Excel- | Excel- | Bad | Good |
| | | lent | | lent | lent | | |
| Head reliability (White) | Good | Excel- | Excel- | Excel- | Excel- | Excel- | Excel- |
| | | lent | lent | lent | lent | lent | lent |
| Head reliability (Color) | Excel- | Good | Good | Good | Excel- | Excel- | Excel- |
| | lent | | | | lent | lent | lent |
| Cracking resistance | Good | Good | Good | Good | Bad | Good | Good |

### Recording Method

A Seiko Epson ink jet printer SC-530650 was modified by providing a support member capable of transporting a cloth secured thereto. A nozzle line was charged with a first ink composition, and another nozzle line was charged with a second ink composition. A reaction liquid was sprayed onto a recording region (square of 15 cm by 15 cm) of a cloth that is a T-shirt fabric (Heavy Weight, 100% cotton, black, manufactured by Hanes) at a deposition rate of 7 mg/inch². Immediately after this spraying, the cloth was fixed to the support member of the printer. A solid pattern of the first ink composition was formed on the recording region, where the reaction liquid had been applied, by an ink jet method at a deposition rate of 200 mg/inch² and dot resolutions of 2880 dpi×2880 dpi. Immediately after forming the solid pattern, the support member was returned, and the second ink composition was applied onto the same recording region by an ink jet method at a deposition rate of 15 mg/inch² and dot resolutions of 720 dpi×720 dpi. After the application, the cloth was removed from the support member and heated in an oven at 150° C. for 1 minute for drying. The percentage of the volatile components of each reaction liquid remaining on the cloth was 90% by mass or more immediately before the first ink composition was applied.

Recorded articles of Examples 1 to 13 and Comparative Examples 1 to 3 were formed using the combinations of the reaction liquid, the first ink composition and the second ink composition shown in Table 2. Table 2 also shows the ratio of the polymer fine particle solids content (percent by mass) in the first ink composition to the polymer fine particle solids content (percent by mass) in the second ink composition in each of the Examples and Comparative Examples.

The resulting recorded articles of Examples 1 to 13 and Comparative Examples 1 to 3 were evaluated as below. Image Quality

Each image was checked for unevenness after being printed and fixed. The evaluation criteria were as follows, and the results are shown in Table 2:

Good: Uniform image with no unevenness

Fair: Slight unevenness was observed.

Bad: Non-uniform image with unevenness Color Fastness to Washing

The color fastness to washing was measured according to the B-5 method specified in JIS L 0844. The evaluation criteria were as follows, and the results are shown in Table 2:

Excellent: Between Grades 4 and 5 or higher

Good: Grade 4

Fair: Grade 3 or between Grade 3 and 4

Bad: Lower than Grade 3 Color Fastness to Rubbing

The color fastness to rubbing was measured according to ISO 105 X2. The evaluation criteria were as follows, and the results are shown in Table 2:

Excellent: Between Grades 3 and 4 or higher

Good: Grade 3

Fair: Grade 2 or between Grade 2 and 3

Bad: Lower than Grade 2 Head Reliability

Head reliability was evaluated by allowing the printer charged with the inks to stand in an environment of 40° C. and 20% RH (relative humidity) with the nozzles open, and then checking ejection of the inks. The number of nozzles was 360. The evaluation criteria were as follows, and the results are shown in Table 2:

Excellent: After a month, the inks were normally ejected through all the nozzles after nozzles were subjected to suction creasing and an inspection.

Good: After two weeks, the inks were normally ejected through all the nozzles after nozzles were subjected to suction creasing and an inspection.

Bad: After two weeks, the inks were not normally ejected through some of the nozzles after nozzles were subjected to suction creasing and an inspection.

As shown in Table 2, the images or inks of Examples 1 to 13 produced better results than those of Comparative Examples 1 to 3, in terms of image quality, color fastness to washing and rubbing, head reliability, and cracking resistance.

The entire disclosure of Japanese Patent Application No. 2015-000161, filed Jan. 5, 2015 is expressly incorporated by reference herein.

What is claimed is:

1. A recording method comprising:
depositing a reaction liquid onto a recording region of a recording medium, the reaction liquid containing a flocculant capable of forming an aggregate of at least one constituent in an ink composition or increasing the viscosity of the ink composition;
depositing a first ink composition onto the recording region on which the reaction liquid has been deposited, the first ink composition containing a coloring material, polymer fine particles made of a resin being an acrylic resin, and water; and
depositing a second ink composition onto the recording region on which the first ink composition has been deposited, the second ink composition containing a coloring material, polymer fine particles made of a resin being a urethane resin, and water.

2. The recording method according to claim 1, wherein the first ink composition is deposited onto the recording region at a rate of 90 mg/inch² to 250 mg/inch², and the second ink composition is deposited onto the recording region at a rate of 10 mg/inch² to 30 mg/inch².

3. The recording method according to claim 1, wherein the resin of the polymer fine particles of the first ink composition is an emulsifier-emulsifiable acrylic resin, and the resin of the polymer fine particles of the second ink composition is a self-emulsifiable urethane resin.

4. The recording method according to claim 1, wherein the recording medium is a cloth.

5. The recording method according to claim 1, wherein the content of polymer fine particle solids in the first ink composition is 7% to 18% by mass relative to the total mass of the first ink composition, and the content of polymer fine particle solids in the second ink composition is 2% to 7% by mass relative to the total mass of the second ink composition.

6. The recording method according to claim 1, wherein the first and the second ink composition are deposited by an ink jet method.

7. The recording method according to claim 1, wherein the ratio of the polymer fine particle solids content in the first ink composition to the polymer fine particle solids content in the second ink composition is 1 to 9 on a mass basis.

8. The recording method according to claim 1, wherein the first ink composition is deposited onto the recording region in a state where the volatile component of the reaction liquid remains 40% by mass or more.

9. The recording method according to claim 1, wherein first ink composition is a white ink composition containing a white coloring material as the coloring material, and the second ink composition is a color ink composition containing a non-white coloring material as the coloring material.

10. An ink set comprising:
the reaction liquid, the first ink composition and the second ink composition that are used in the recording method as set forth in claim 1.

11. An ink set comprising:
the reaction liquid, the first ink composition and the second ink composition that are used in the recording method as set forth in claim 2.

12. An ink set comprising:
the reaction liquid, the first ink composition and the second ink composition that are used in the recording method as set forth in claim 3.

13. An ink set comprising:
the reaction liquid, the first ink composition and the second ink composition that are used in the recording method as set forth in claim 4.

14. An ink set comprising:
the reaction liquid, the first ink composition and the second ink composition that are used in the recording method as set forth in claim 5.

15. An ink set comprising:
the reaction liquid, the first ink composition and the second ink composition that are used in the recording method as set forth in claim 6.

16. An ink set comprising:
the reaction liquid, the first ink composition and the second ink composition that are used in the recording method as set forth in claim 7.

17. An ink set comprising:
the reaction liquid, the first ink composition and the second ink composition that are used in the recording method as set forth in claim 8.

18. An ink set comprising:
the reaction liquid, the first ink composition and the second ink composition that are used in the recording method as set forth in claim 9.
